(19) United States
(12) Patent Application Publication
(10) Pub. No.: US 2026/0190131 A1
(43) Pub. Date: Jul. 2, 2026

(54) METHOD AND APPARATUS FOR PROVIDING AMBIENT IOT SERVICE

(71) Applicant: KT CORPORATION, Gyeonggi-do (KR)

(72) Inventor: Sung-pyo HONG, Gyeonggi-do (KR)

(73) Assignee: KT CORPORATION, Gyeonggi-do (KR)

(21) Appl. No.: 19/439,256

(22) Filed: Jan. 2, 2026

(30) Foreign Application Priority Data
Jan. 2, 2025 (KR) 10-2025-0000560
Dec. 18, 2025 (KR) 10-2025-0203373

(51) Int. Cl. H04W 72/51; G16Y 10/75

(52) U.S. Cl. CPC H04W 72/51; G16Y 10/75

(57) ABSTRACT

Provided are a method and device for providing an ambient IoT service in a wireless communication system. A reader receives, from an ambient internet of things function (AIoTF), a first message for requesting an ambient internet of things (AIoT). Further, after receiving the first message, the reader receives, from the AIoTF, a second message for instructing release of the AIoT service, and in response to the second message, transmits, to the AIoTF, a third message for indicating completion of release of the AIoT service.

### CROSS-REFERENCE TO RELATED THE APPLICATION

This application is based on and claims priority under 35 U.S.C. § 119 to Patent Application No. 10-2025-0000560 filed on Jan. 2, 2025 and No. 10-2025-0203373 filed on Dec. 18, 2025 in the Korean Intellectual Property Office, the disclosures of which are incorporated by reference herein in their entirety.

### BACKGROUND

### Technical Field

The present disclosure relates to wireless communication applicable to 5G NR, 5G-Advanced and 6G.

### Description of the Related Art

With the increase in the number of communication devices, there is a consequent rise in communication traffic that needs to be managed. To handle this increased communication traffic, a next generation 5G system, which is an enhanced mobile broadband communication system compared to the exiting LTE system, has become necessary. Such a next generation 5G system has been developed based on scenarios classified as Enhanced Mobile BroadBand (eMBB), Ultra-reliable and low-latency communication (URLLC), Massive Machine-Type Communications (mMTC), and the like.

eMBB, URLLC, and mMTC represent next generation mobile communication scenarios. eMBB is characterized by high spectral efficiency, high user experienced data rate, high peak data. URLLC is characterized by ultra-reliability, ultra-low latency, ultra-high availability (e.g., vehicle-to-everything (V2X), Emergency Service, Remote Control). mMTC is characterized by low cost, low energy consumption, short packet transmission, and massive connectivity (e.g., Internet of Things (IoT)).

### SUMMARY

The disclosure provides a method and apparatus for efficiently providing an ambient IoT service in a wireless communication system.

According to an embodiment, an operation method of a reader in a wireless communication system may be provided. The method of the reader may include receiving, from an ambient internet of things function (AIoTF), a first message for requesting an ambient internet of things (AIoT) service, after receiving the first message, receiving, from the AIoTF, a second message for instructing release of the AIoT service, and in response to the second message, transmitting, to the AIoTF, a third message for indicating completion of release of the AIoT service.

According to another embodiment, a reader in a wireless communication system may be provided. The reader may include at least one processor; and at least one memory configured to store instructions and operably electrically connectable to the at least one processor, wherein operations performed based on the instructions executed by the at least one processor include: receiving, from an ambient internet of things function (AIoTF), a first message for requesting an ambient internet of things (AIoT) service, after receiving the first message, receiving, from the AIoTF, a second message for instructing release of the AIoT service, and in response to the second message, transmitting, to the AIoTF, a third message for indicating completion of release of the AIoT service.

After receiving the first message, the reader may transmit a fourth message to an AIoT device for paging. Here, the fourth message may include information indicating whether a security parameter is included.

Meanwhile, the first message may further include at least one of AIoT device identification information and a security parameter, and may be received via NG application protocol (NGAP) between the AIoTF and a base station. The AIoT device identification information may include one of permanent AIoT device identification information, first security-processed identification information, and filtering information, and the security parameter may be a random parameter used to generate second security-processed identification information.

In addition, the second message may include identification information associated with the request for the AIoT service, AIoTF identification information, and cause information.

Further, the third message may include identification information associated with the request for the AIoT service and AIoTF identification information.

### BRIEF DESCRIPTION OF THE DRAWINGS

FIG. 1 is a diagram illustrating a wireless communication system.

FIG. 2 is a diagram illustrating a structure of a radio frame used in new radio (NR).

FIGS. 3A to 3C illustrate exemplary architectures for a wireless communication service.

FIG. 4 illustrates a slot structure of an NR frame.

FIG. 5 shows an example of a subframe type in NR.

FIG. 6 illustrates a structure of a self-contained slot.

FIGS. 7A to 7B illustrate examples of connectivity topologies for an ambient IoT network and a device.

FIG. 8 illustrates an example of a procedure for an A-IoT inventory service.

FIG. 9 illustrates an example of an access stratum (AS) procedure between an A-IoT device and a reader.

FIG. 10 is a flowchart showing a method of operating a reader according to an embodiment.

FIG. 11 is a flowchart showing a method of operating a reader according to another embodiment.

FIG. 12 is a block diagram showing apparatuses according to an embodiment of the disclosure.

FIG. 13 is a block diagram showing a terminal according to an embodiment of the disclosure.

FIG. 14 is a block diagram of a processor in accordance with an embodiment.

FIG. 15 is a detailed block diagram of a transceiver of a first apparatus shown in FIG. 12 or a transceiving unit of an apparatus shown in FIG. 13.

### DETAILED DESCRIPTION

The technical terms used in this document are for merely describing specific embodiments and should not be considered limiting the embodiments of disclosure. Unless defined otherwise, the technical terms used in this document should be interpreted as commonly understood by those skilled in the art but not too broadly or too narrowly. If any technical terms used here do not precisely convey the intended meaning of the disclosure, they should be replaced with or interpreted as technical terms that accurately understood by those skilled in the art. The general terms used in this document should be interpreted according to their dictionary definitions, without overly narrow interpretations.

The singular form used in the disclosure includes the plural unless the context dictates otherwise. The term ‘include’ or ‘have’ may represent the presence of features, numbers, steps, operations, components, parts or the combination thereof described in the disclosure. The term ‘include’ or ‘have’ may not exclude the presence or addition of another feature, another number, another step, another operation, another component, another part or the combination thereof.

The terms ‘first’ and ‘second’ are used to describe various components without limiting them to these specific terms. The terms ‘first’ and ‘second’ are only used to distinguish one component from another component. For example, a first component may be named as a second component without departing from the scope of the disclosure.

When an element or layer is referred to as being “connected to” or “coupled to” another element or layer, it may be directly connected or coupled to the other element or layer, there might be intervening elements or layers. In contrast, when an element or layer is referred to as being “directly connected to” or “directly coupled to” another element or layer, there are no intervening elements or layers.

Hereinafter, the exemplary embodiments of the disclosure will be described in detail with reference to the accompanying drawings. In describing the disclosure, for ease of understanding, the same reference numerals will be used throughout the drawings for the same components, and repetitive description on these components will be omitted. Detailed description on well-known arts that may obscure the essence of the disclosure will be omitted. The accompanying drawings are provided to merely facilitate understanding of the embodiment of disclosure and should not be seen as limiting. It should be recognized that the essence of this disclosure extends the illustrations, encompassing, replacements or equivalents in variations of what is shown in the drawings.

In this disclosure, “A or B” may mean “only A”, “only B”, or “both A and B”. In other words, “A or B” in the disclosure may be interpreted as “A and/or B”. For example, “A, B or C” may mean “only A”, “only B”, “only C”, or “any combination of A, B and C”.

In this disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In this disclosure, “at least one of A and B” may mean “only A”, “only B” or “both A and B”. In addition, “at least one of A or B” or “at least one of A and/or B” may be interpreted as the same as “at least one of A and B”.

In addition, “at least one of A, B and C” may mean “only A”, “only B”, “only C”, or “any combination of A, B and C”. Further, “at least one of A, B or C” or “at least one of A, B and/or C” may mean “at least one of A, B and C”.

Also, parentheses used in this disclosure may mean “for example”. For example, “control information (PDCCH)” may mean that “PDCCH” is an example of “control information”. However, “control information” in this disclosure is not limited to “PDCCH”. As another example, “control information (i.e., PDCCH)”, may also mean that “PDCCH” is an example of “control information”.

Each of the technical features described in one drawing in this disclosure may be implemented independently or simultaneously.

In the accompanying drawings, user equipment (UE) is illustrated as an example and may be referred to as a terminal, mobile equipment (ME), and the like. UE may be a portable device such as a laptop computer, a mobile phone, a personal digital assistance (PDA), a smart phone, a multimedia device, or the like. UE may be a non-portable device such as a personal computer (PC) or a vehicle-mounted device.

Hereinafter, the UE may be as an example of a device capable of wireless communication. The UE may be referred to as a wireless communication device, a wireless device, or a wireless apparatus. The operation performed by the UE may be applicable to any device capable of wireless communication. A device capable of wireless communication may also be referred to as a radio communication device, a wireless device, or a wireless apparatus.

A base station generally refers to a fixed station that communicates with a wireless device. The base station may include an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), and the repeater (relay).

While embodiments of the disclosure are described based on an long term evolution (LTE) system, an LTE-advanced (LTE-A) system, and an new radio (NR) system, such embodiments may be applicable to any communication system that fits the described criteria.

### <Wireless Communication System>

With the success of long-term evolution (LTE)/LTE-A (LTE-Advanced) for the 4th generation mobile communication, the next generation mobile communication (e.g., 5th generation: also known as 5G mobile communication) has been commercialized and the follow-up studies are also ongoing.

The 5th generation mobile communications, as defined by the International Telecommunication Union (ITU), provide a data transmission rate of up to 20 Gbps and a minimum actual transmission rate of at least 100 Mbps anywhere. The official name of the 5th generation mobile telecommunications is ‘IMT-2020’.

ITU proposes three usage scenarios: enhanced Mobile Broadband (eMBB), massive Machine Type Communication (mMTC) and Ultra Reliable and Low Latency Communications (URLLC).

URLLC is a usage scenario requiring high reliability and low latency. For example, services such as automatic driving, factory automation, augmented reality require high reliability and low latency (e.g., a delay time of less than 1 ms). The delay time of current 4G (e.g., LTE) is statistically about 21 to 43 ms (best 10%) and about 33 to 75 ms (median), which insufficient to support services requiring a delay time of about 1 ms or less. Meanwhile, eMBB is a usage scenario that requires mobile ultra-wideband.

That is, the 5G mobile communication system offers a higher capacity compared to current 4G LTE. The 5G mobile communication system may be designed to increase the density of mobile broadband users and support device to device (D2D), high stability, and machine type communication (MTC). 5G research and development focus on achieving lower latency times and lower battery consumption compared to 4G mobile communication systems, enhancing the implementation of the Internet of things (IoTs). A new radio access technology, known as new RAT or NR, may be introduced for such 5G mobile communication.

An NR frequency band is defined to include two frequency ranges FR1 and FR2. Table 1 below shows an example of the two frequency ranges FR1 and FR2. However, the numerical values associated with each frequency range may be subject to change, and the embodiments are not limited thereto. For convenience of description, FR1 in the NR system may refer to a Sub-6 GHz range, and FR2 may refer to an above-6 GHz range, which may be called millimeter waves (mmWs).

TABLE 1

| Frequency Range | Corresponding frequency | Subcarrier | |
|---|---|---|---|
| designation | range | Spacing | |
| FR1 | 410 MHz-7125 MHz | 15, 30, 60 | kHz |
| FR2 | 24250 MHz-52600 MHz | 60, 120, 240 | kHz |

The numerical values of the frequency ranges may be subject to change in the NR system. For example, FR1 may range from about 410 MHz to 7125 MHz as listed in [Table 1]. That is, FR1 may include a frequency band of 6 GHz (or 5850, 5900, and 5925 MHz) or higher. For example, the frequency band of 6 GHz (or 5850, 5900, and 5925 MHz) or higher may include an unlicensed band. The unlicensed band may be used for various purposes, for example, vehicle communication (e.g., autonomous driving).

The 3GPP communication standards define downlink (DL) physical channels and DL physical signals. DL physical channels are related to resource elements (REs) that convey information from a higher layer while DL physical signals, used in the physical layer, correspond to REs that do not carry information from a higher layer. For example, DL physical channels include physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH). DL physical signals include reference signals (RSs) and synchronization signals (SSs). A reference signal (RS) is also known as a pilot signal and has a predefined special waveform known to both a gNode B (gNB) and a UE. For example, DL RSs include cell specific RS, UE-specific RS (UE-RS), positioning RS (PRS), and channel state information RS (CSI-RS). The 3GPP LTE/LTE-A standards also define uplink (UL) physical channels and UL physical signals. UL channels correspond to REs with information from a higher layer. UL physical signals are used in the physical layer and correspond to REs which do not carry information from a higher layer. For example, UL physical channels include physical uplink shared channel (PUSCH), physical uplink control channel (PUCCH), and physical random access channel (PRACH). UL physical signals include a demodulation reference signal (DMRS) for a UL control/data signal, and a sounding reference signal (SRS) used for UL channel measurement.

In this disclosure, PDCCH/PCFICH/PHICH/PDSCH refers to a set of time-frequency resources or a set of REs carrying downlink control information (DCI)/a control format indicator (CFI)/a DL acknowledgement/negative acknowledgement (ACK/NACK)/DL data. Further, PUCCH/PUSCH/PRACH refers to a set of time-frequency resources or a set of REs carrying UL control information (UCI)/UL data/a random access signal.

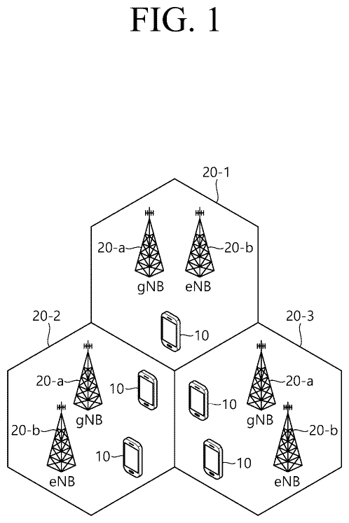

FIG. 1 is a diagram illustrating a wireless communication system.

Referring to FIG. 1, the wireless communication system may include at least one base station (BS). For example, the BSs may include a gNodeB (or gNB) 20a and an eNodeB (or eNB) 20b. The gNB 20a supports 5G mobile communication. The eNB 20b supports 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, there are other cells adjacent to the serving cell. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, a transmitter may be a part of the base station 20, and a receiver may be a part of the UE 10. In the uplink, the transmitter may be a part of the UE 10, and the receiver may be a part of the base station 20.

In a wireless communication system, there are primarily two schemes: frequency division duplex (FDD) scheme and time division duplex (TDD) scheme. In the FDD scheme, uplink transmission and downlink transmission occur on different frequency bands. Conversely, the TDD scheme allows both uplink transmission and downlink transmission to use the same frequency band, but at different times. A key characteristic of the TDD scheme is the substantial reciprocity of the channel response, meaning that the downlink channel response and the uplink channel response are almost identical within a given frequency domain. This reciprocity in TDD-based radio communication systems enables the estimation of the downlink channel response from the uplink channel response. In the TDD scheme, since uplink transmission and downlink transmission are time-divided in the entire frequency band, it is not possible to simultaneously perform downlink transmission by the base station and uplink transmission by the UE. In a TDD system where uplink transmission and downlink transmission are divided into subframe units, uplink transmission and downlink transmission are performed in different subframes.

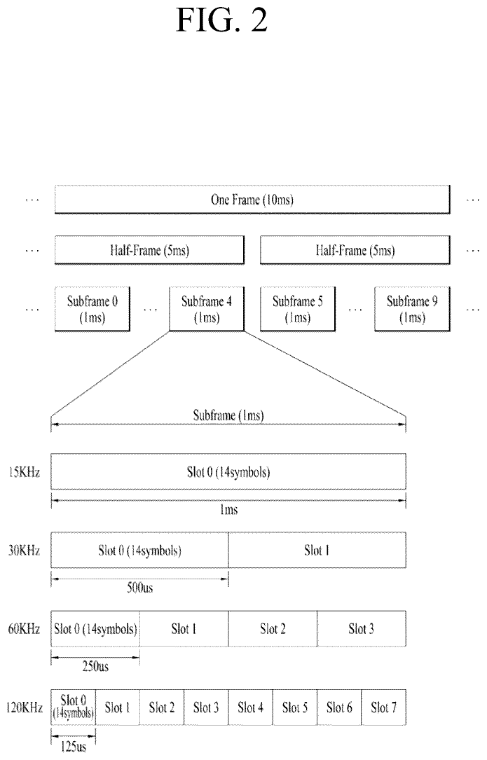

FIG. 2 is a diagram illustrating a structure of a radio frame used in new radio (NR).

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on the subcarrier spacing (SCS). Each slot includes 12 or 14 OFDM (A) symbols according to a Cyclic Prefix (CP). With a normal CP, a slot includes 14 OFDM symbols. With an extended CP, a slot includes 12 OFDM symbols. A symbol may include an OFDM symbol (CP-OFDM symbol) and an SC-FDMA symbol (or DFT-s-OFDM symbol).

### <Support of Various Numerologies>

As wireless communication technology advances, the NR system may offer various numerologies to terminals. For example, when a subcarrier spacing (SCS) is set at 15 kHz, it supports a broad range of the typical cellular bands. When a subcarrier spacing (SCS) is set at 30 kHz/60 kHz, it supports a dense-urban, lower latency, wider carrier bandwidth. When the SCS is 60 kHz or higher, it supports a bandwidth greater than 24.25 GHz in order to overcome phase noise.

These numerologies may be defined by the cyclic prefix (CP) length and the SCS. A single cell in the NR system is capable of providing multiple numerologies to terminals. Table 2 below shows the relationship between the subcarrier spacing, corresponding CP length, and the index of a numerology (represented by u).

TABLE 2

| μ | Δf = 2^{μ} · 15 [kHz] | CP |
|---|---|---|
| 0 | 15 | normal |
| 1 | 30 | normal |
| 2 | 60 | normal, extended |
| 3 | 120 | normal |
| 4 | 240 | normal |
| 5 | 480 | normal |
| 6 | 960 | normal |

Table 3 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) according to each numerology expressed by u in the case of a normal CP.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

Table 4 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) of a numerology represented by u in the case of an extended CP.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz (u = 2) | 12 | 40 | 4 |

In the NR system, OFDM (A) numerologies (e.g., SCS, CP length, and so on) may be configured differently across multiple cells that are integrated with a single terminal. Accordingly, the duration of time resource may vary among these integrated cells. Here, the duration may be referred to as a section. The time resource may include a subframe, a slot or a transmission time interval (TTI). Further, the time resource may be collectively referred to as a time unit (TU) for simplicity and include the same number of symbols.

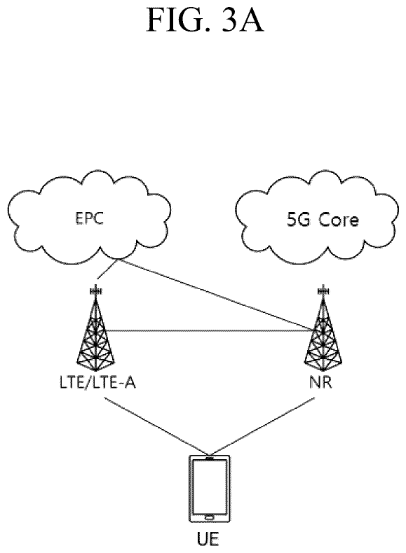

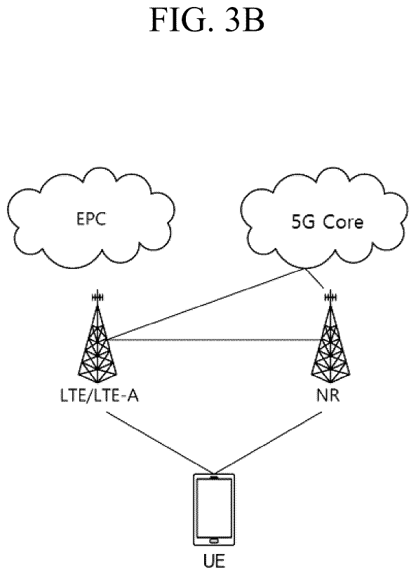

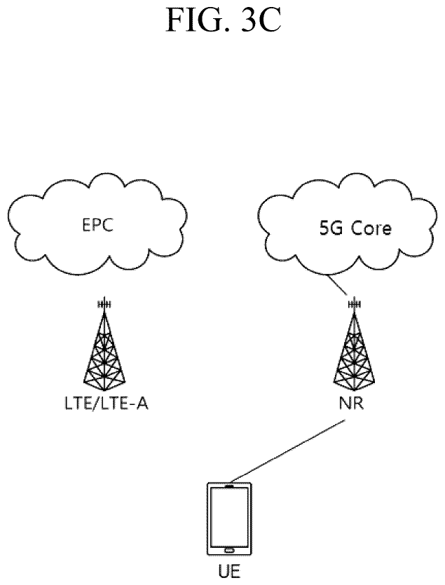

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, Evolved Packet core (EPC).

Referring to FIG. 3B, the LTE/LTE-A cell is connected with a core network for 5th generation mobile communication, that is, a 5G core network.

A service provided by the architecture shown in FIGS. 3A and 3B is referred to as a non-standalone (NSA) service.

Referring to FIG. 3C, a UE is connected only with an NR cell. A service provided by this architecture is referred to as a standalone (SA) service.

In the new radio access technology (NR), the use of a downlink subframe for reception from a base station and an uplink subframe for transmission to the base station may be employed. This method may be applicable to both paired spectrums and unpaired spectrums. Paired spectrums involve two subcarriers designated for downlink and uplink operations. For example, one subcarrier within a pair of spectrums may include a pair of a downlink band and an uplink band.

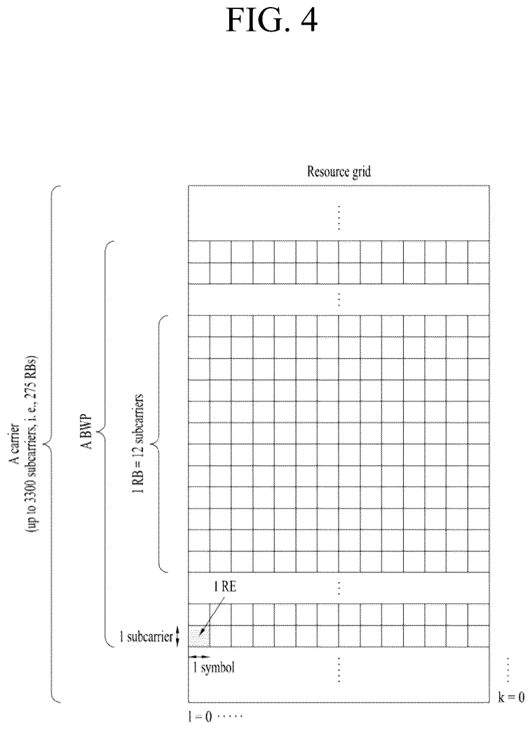

FIG. 4 illustrates a slot structure of an NR frame.

A slot in the NR system includes a plurality of symbols in the time domain. For example, in the case of the normal CP, one slot includes seven symbols. On the other hand, in the case of the extended CP, one slot includes six symbols. A carrier includes a plurality of subcarriers in the frequency domain. A resource block (RB) is defined as a set of consecutive subcarriers (e.g., 12 consecutive subcarriers) in the frequency domain. A bandwidth part (BWP) is defined as a sequence of consecutive physical resource blocks (PRBs) in the frequency domain and may be associated with a specific numerology (e.g., SCS, CP length, etc.). A terminal may be configured with up to N (e.g., five) BWPs in each of downlink and uplink. Downlink or uplink transmission is performed through an activated BWP. Among the BWPs configured for the terminal, only one BWP may be activated at a given time. In the resource grid, each element is referred to as a resource element (RE), and one complex symbol may be mapped thereto.

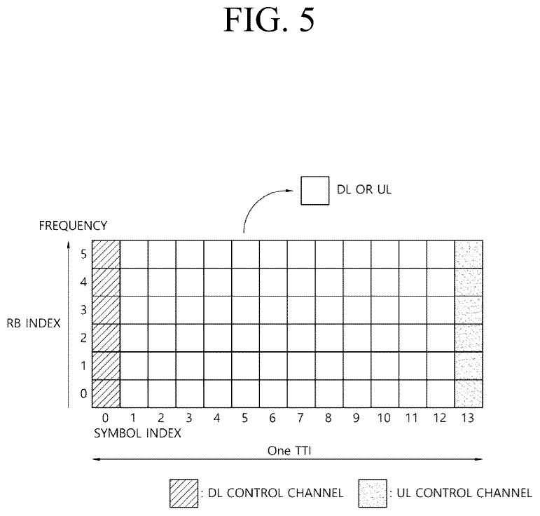

FIG. 5 shows an example of a subframe type in NR.

In NR (or new RAT), a Transmission Time Interval (TTI), as shown in FIG. 5, may be referred to as a subframe or slot. The subframe (or slot) may be utilized in a TDD system to minimize data transmission delay. As shown in FIG. 5, a subframe (or slot) includes 14 symbols. The symbol at the head of the subframe (or slot) may be allocated for a DL control channel, and the symbol at the end of the subframe (or slot) may be assigned for a UL control channel. The remaining symbols may be used for either DL data transmission or UL data transmission. This subframe (or slot) structure allows sequential downlink and uplink transmissions in one single subframe (or slot). Accordingly, downlink data may be received in a subframe (or slot) and uplink ACK/NACK may be transmitted in the same subframe (or slot).

Such a subframe (or slot) structure may be referred to as a self-contained subframe (or slot).

The first N symbols in a slot may be used to transmit a DL control channel and referred to as a DL control region, hereinafter. The last M symbols in the slot may be used to transmit a UL control channel and referred to as a UL control region. N and M are integers greater than 0. A resource region between the DL control region and the UL control region may be used for either DL data transmission or UL data transmission and referred to as a data region. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

Using this subframe (or slot) structure reduces the time required for retransmitting data that has failed in reception, thereby minimizing overall data transmission latency. In such a self-contained subframe (or slot) structure, a time gap may be required for transitioning between a transmission mode and a reception mode or from the reception mode to the transmission mode. To accommodate this, a few OFDM symbols when switch from DL to UL in the subframe structure may be configured to a guard period (GP).

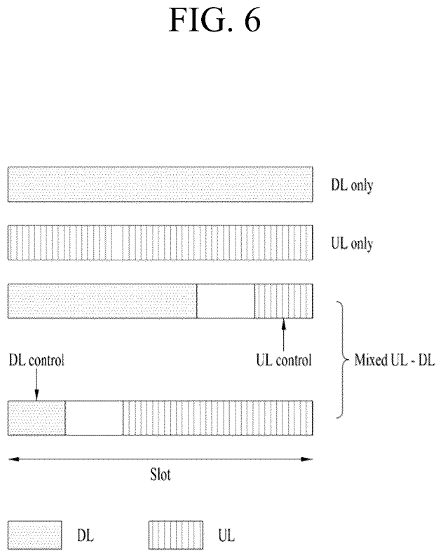

FIG. 6 illustrates a structure of a self-contained slot.

In the NR system, the frames are structured as a self-contained structure, where one single slot includes a DL control channel, either a DL or UL data channel, and UL control channel. For example, the first N symbols in a slot may be used for transmitting a DL control channel and referred to as a DL control region. The last M symbols in the slot may be used for transmitting an UL control channel and referred to as a UL control region. N and M are integers greater than 0. A resource region between the DL control region and the UL control region may be used for either DL data transmission or UL data transmission and referred to as a data region.

For example, the following configurations may be considered. The durations are listed in temporal order.
1. DL only configuration
2. UL only configuration
3. Mixed UL-DL configuration
   DL region+Guard Period (GP)+UL control region
   DL control region+GP+UL region
DL region: (i) DL data region, (ii) DL control region+DL data region
UL region: (i) UL data region, (ii) UL data region+UL control region

A physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Through the PDCCH, Downlink Control Information (DCI), for example, DL data scheduling information or UL data scheduling data may be transmitted. Through the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A guard period (GP) provides a time gap during a process where a gNB and a UE transition from the transmission mode to the reception mode or a process where the gNB and UE transition from the reception mode to the transmission mode. Some symbols within a subframe that transition from DL to UL mode may be configured as the GP.

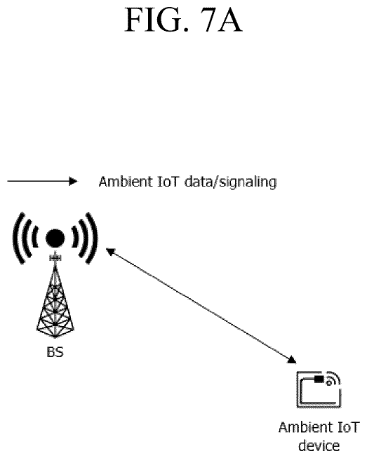

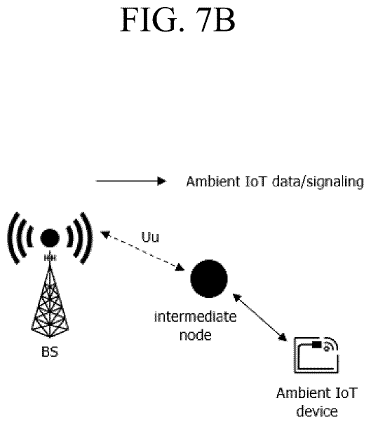

FIGS. 7A to 7B illustrate examples of connectivity topologies for an ambient IoT network and a device.

An ambient Internet of Things (ambient Internet of Things or ambient power-enabled Internet of Things: A-IoT/AIoT) device is an IoT device powered by energy harvesting and having no battery or having limited energy storage capability (for example, using a capacitor). For convenience of description, an AIoT device may hereinafter be referred to as a device. This is merely for convenience of description, and the name may be changed to any other term.

Energy is provided through energy harvesting from radio waves, light, motion, heat, or other suitable power sources. Energy harvesting may be continuous (for example, by vibration) or may occur intermittently. Accordingly, it cannot be assumed that an AIoT device always has power available for data transmission and reception.

An AIoT device needs to be designed to have lower complexity, smaller size, reduced capability, and lower power consumption than previously defined 3GPP IoT terminals/devices (for example, NB-IoT (Narrowband Internet of Things) or eMTC (enhanced Machine Type Communication) devices). An AIoT device may be designed to have a lifetime of more than 10 years without maintenance. Accordingly, AIoT devices may replace existing 3GPP IoT devices or support various use cases (for example, inventory, sensors, positioning, and commands) that cannot be supported by existing 3GPP IoT devices.

Functions and procedures for supporting ambient IoT use cases may be defined as AIoT services (for example, an inventory service and a command service). For example, a main purpose of the inventory service is to search for goods (for example, boxes, containers, packages, or tools) present in a specific area. When a request is transmitted within a network for a specific area, AIoT devices attached to such goods report identifiers associated with the goods, and additional information such as status, measurement results, and/or location may be added by the AIoT devices and/or an AIoT RAN (Radio Access Network)/reader. Through the inventory service, AIoT devices within a predetermined range of a specific reader may be discovered and/or tracked.

A command service represents a procedure for executing commands for AIoT devices located in a specific area. The commands may include, for example, read, write, disable, and/or enable services.
Read: a request to read information from an AIoT device.
Write: a request to write information to an AIoT device.
Disable: a request to permanently or temporarily disable an RF transmission capability of an AIoT device.
Enable: a request to enable an AIoT device that has been temporarily disabled.

Connectivity topologies such as those shown in FIGS. 7A to 7B may be defined for an ambient Internet of Things (AIoT) network and devices. In FIG. 7A, a BS represents an ambient IoT Radio Access Network (RAN). The AIoT RAN represents a node that performs specific functions for AIoT as part of a functional split between a Radio Access Network (RAN) and a Core Network (CN), for example, a RAN node function that includes control of A-IoT radio resources used by an A-IoT device. The AIoT RAN may serve one or more AIoT readers. An AIoT reader represents a reader that terminates an AIoT protocol with an AIoT device. For convenience of description, the node may hereinafter be referred to as an AIoT RAN (or an AIoT reader). This is merely for convenience of description, and the node may be denoted by any other term, such as an AIoT RAN reader, an AIoT base station, or an AIoT BS reader.

In all of these topologies, a carrier may be provided to an AIoT device from another node inside or outside the topology. Links in each topology may be bidirectional or unidirectional. In FIG. 7A, an AIoT device communicates directly and bidirectionally with a base station. Communication between the base station and the AIoT device may include AIoT data and/or signaling. A base station that transmits to the AIoT device and a base station that receives from the AIoT device may be the same base station or may be different base stations.

In FIG. 7B, an AIoT device performs bidirectional communication with an AIoT RAN via an intermediate node/assisting node/assisting UE. In this topology, the intermediate node/assisting node/assisting UE may be a relay, an integrated access and backhaul (IAB) node, a UE, a repeater, or the like, which is capable of ambient IoT functions and/or services. For convenience of description, the node may hereinafter be referred to as a UE reader. This is merely for convenience of description, and the node may be denoted by any other term, such as a UE connected to or associated with an AIoT-enabled RAN, an AIoT-enabled RAN/reader, an AIoT reader, or an AIoT UE reader.

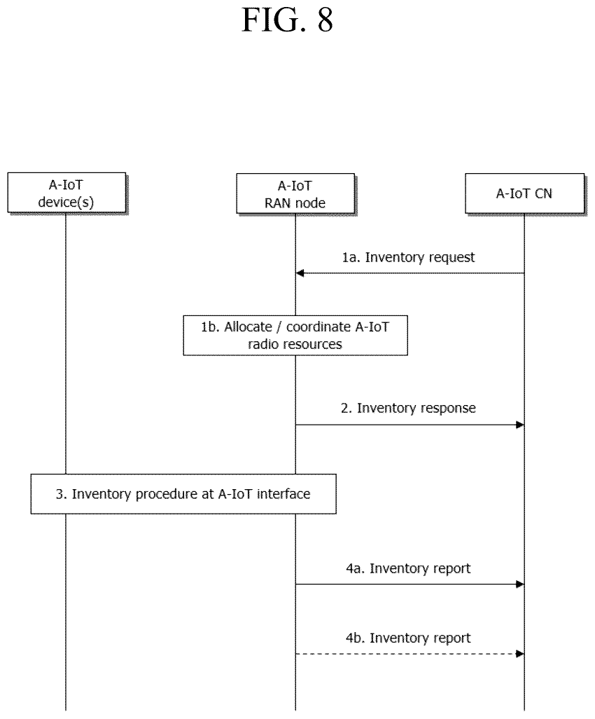

FIG. 8 illustrates an example of a procedure for an A-IoT inventory service.

With reference to FIG. 8, a procedure for an AIoT inventory service is described below.
1a. The A-IoT CN sends an inventory request message to an A-IoT RAN node.
1b. The A-IoT RAN node allocates and coordinates usage of A-IoT radio resources.
2. The A-IoT RAN node sends an inventory response message to the A-IoT CN.
3. The A-IoT RAN node performs an inventory procedure toward one or more A-IoT devices over an A-IoT radio interface.
4a/4b. After receiving inventory results from the one or more A-IoT devices, the A-IoT RAN node may transmit one or more inventory reports to the A-IoT CN, the inventory reports including the received inventory results.

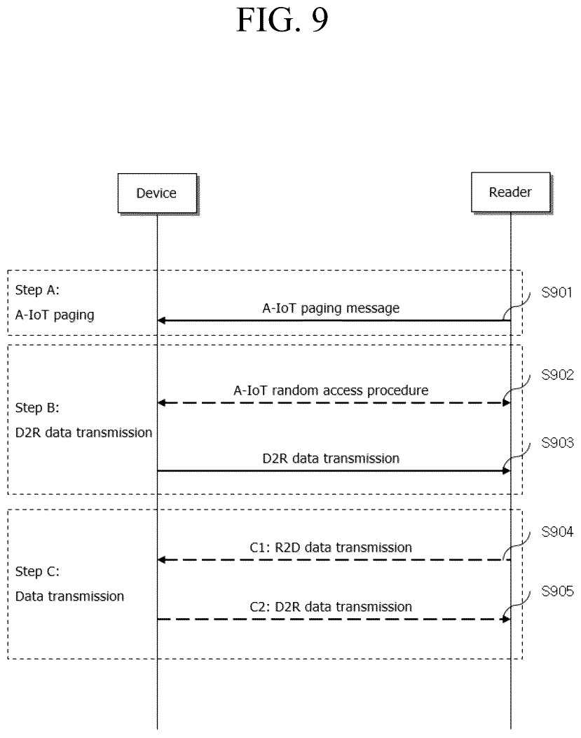

FIG. 9 illustrates an example of an access stratum (AS) procedure between an A-IoT device and a reader.

With reference to FIG. 9, an overall access stratum (AS) procedure between an ambient Internet of Things (A-IoT) device and a reader is described below.

### Step A: A-IoT Paging (S901)

Based on a service request, the reader transmits an A-IoT paging message indicating one or more devices that are required to respond. In this case, the A-IoT paging message may be used interchangeably with an initial trigger message.

### Step B: D2R (Device-to-Reader) Data Transmission (S902-S903)

One or more A-IoT devices triggered by the paging perform transmission of a device identity (ID) to the reader by performing an A-IoT random access procedure or without performing the A-IoT random access procedure. Thereafter, D2R data is transmitted to the reader.

### Step C1: R2D (Reader-to-Device) Data Transmission (S904)

A possible R2D data transmission is performed, for example, for transmitting a command.

### Step C2: D2R Data Transmission (S905)

A possible D2R data transmission is performed, for example, for transmitting a corresponding response to the command.

Accordingly, although high-level procedures for providing an inventory service or a command service have been defined, detailed operations between an AIoT device and an AIoT RAN/reader for supporting AIoT services have not been specified, and thus AIoT services could not be implemented. In particular, no specific method has been defined for handling success or failure of an AIoT service.

In providing AIoT technologies that support lower complexity, smaller size, reduced capability, and lower power consumption than existing 3GPP LPWA (Low-Power Wide-Area) IoT, no specific method has been defined for handling success or failure of an AIoT service.

To address these problems, the present disclosure proposes a method for handling success and/or failure of an AIoT service, and an apparatus therefor.

Hereinafter, data transmission and reception methods based on 5GS (Fifth Generation System) and NR technologies are described in detail. However, this is merely for convenience of description, and the present disclosure may be applied based on any system or any radio access technology (for example, 6G). Embodiments described in the present disclosure may refer to information elements and operation details specified in NR/5GS standards (for example, TS 38.321 as an NR MAC specification, TS 38.331 as an NR RRC specification, and TS 23.501 as a system architecture specification). Even if definitions of such information elements and related terminal operations are not described in the present specification, corresponding contents specified in standard specifications as well-known technologies may be included in the present disclosure.

Any function described below may be defined as an individual terminal capability (for example, a UE radio capability or a UE core network capability) and may be transmitted by a terminal to a base station or a core network entity (for example, an AMF (Access and Mobility Management Function), an SMF (Session Management Function), or an AIoTNF (Ambient IoT Network Function)) through corresponding signaling. Alternatively, multiple functions may be combined or aggregated and defined as a terminal capability, and may be transmitted by the terminal to the base station or the core network entity through corresponding signaling. Herein, an AIoTF (Ambient IoT Function or Ambient IoT Network Function) represents a network function for providing management and control of AIoT services and AIoT operations. This is merely for convenience of description, and the name may be changed to any other term. The AIoTF may select an AIoT RAN node (or a UE reader). The AIoTF may receive an AIoT service request from an application function or an application server and trigger an AIoT RAN/reader (or an AIoT UE reader) to perform AIoT device operations and AIoT service operations. The AIoTF may collect AIoT service operation results from the AIoT RAN node (or the AIoT UE reader) and transmit the collected results to the application function or the application server.

An ambient IoT device may be classified and defined into at least one device type or category according to at least one supported capability or a combination of at least one capability. For example, according to an energy storage capacity, devices may be classified into a device having no energy storage, a device having an energy storage capacity up to a specific value (up to E1 Joules), and a device having an energy storage capacity up to another specific value (up to E2 Joules, where E2>E1). As another example, devices may be classified into a device having no energy storage and no independent signal generation or amplification (for example, backscatter transmission) (hereinafter referred to as Device A for convenience of description), a device having an energy storage unit but no independent signal generation (for example, backscatter transmission) (hereinafter referred to as Device B for convenience of description), wherein use of stored energy in Device B may include amplification of a reflected signal, and a device having an energy storage unit and independent signal generation (for example, active RF components for transmission) (hereinafter referred to as Device C for convenience of description). As another example, devices may be classified into a device having approximately 1 μW peak power consumption, having energy storage, having no amplification in both downlink (DL) and uplink (UL) within the device, and performing uplink transmission by backscattering on an externally provided carrier wave (hereinafter referred to as Device 1 for convenience of description); a device having peak power consumption of less than or equal to a few hundred μW, having energy storage, having amplification in both DL and UL within the device, and performing uplink transmission by backscattering on an externally provided carrier wave (hereinafter referred to as Device 2a for convenience of description); and a device having peak power consumption of less than or equal to a few hundred μW, having energy storage, having amplification in both DL and UL within the device, and performing uplink transmission using a carrier wave internally generated by the device (hereinafter referred to as Device 2b for convenience of description).

An AIoT RAN/reader/base station/UE reader or an AIoTF may transmit, indicate, or configure information or messages to an AIoT device to instruct enabling, activation, allowance, support, and/or configuration of any function or any combination of functions described below. For example, such information or messages may be transmitted from the AIoTF to the AIoT device through an AIoT NAS message or container. Alternatively, such information or messages may be transmitted to the AIoT device through a dedicated MAC PDU by an AIoT RAN/reader/base station/UE reader.

An AIoT RAN/reader/base station/UE reader or an AIoTF may transmit, indicate, or configure information or messages to an AIoT device for disabling, deactivating, restricting, and/or controlling any function or any combination of functions described below. For example, a prohibit, suspend, or deactivate timer for operation of a corresponding function may be indicated. The timer may be started or restarted at initiation of the corresponding function or before or after initiation of the corresponding function. While the timer is running, the device may be disabled, deactivated, restricted, or controlled so as not to initiate or perform the corresponding function.

Embodiments and corresponding functions described below may be performed independently. Alternatively, the embodiments and functions described below may be arbitrarily combined or aggregated and implemented, and it is apparent that such implementations are also included within the scope of the present invention.

Any information described below may be traffic characteristic information obtained, calculated, or derived statistically or empirically by a terminal or a network (for example, arbitrary statistics or statistical values such as an expected value/average, variance, standard deviation, minimum, or maximum). Accordingly, any information included in the present specification may represent at least one of an average (expected value), a minimum, a maximum, or a standard deviation. This is merely for convenience of description, and all information in the present specification may be used as statistical information. Any information described below may be pre-configured in a device or a network, or may be provisioned through OAM (Operations, Administration, and Maintenance), an application server, an application function, AIoT, UDM (Unified Data Management), and/or ADM (AIoT Data Management).

Hereinafter, a physical channel for R2D (Reader to Device) data transmission is referred to as a PRDCH (Physical Reader to Device Channel), a physical channel for D2R (Device to Reader) data transmission is referred to as a PDRCH (Physical Device to Reader Channel), and an interface/link between a reader and a device is referred to as an RD interface/link (for example, an AIoT radio interface). This is merely for convenience of description, and may be replaced with any other term.

Hereinafter, RD/DR link resource and scheduling information may include at least one of:
a start time/subframe/slot/symbol/reference time/arbitrary AIoT device unit time (for RD/DR link communication);
a start time/subframe/slot/symbol/reference time/arbitrary AIoT device unit time offset (for RD/DR link communication);
a start time/subframe/slot/symbol based on a specific reference time/point (for example, R2D data reception, start of R2D data reception, end of R2D data reception, or a serving base station/cell-specific reference time serving the corresponding reader);
a start time/subframe/slot/symbol offset based on a specific reference time (for RD/DR link communication);
a duration (for RD/DR link communication);
a transmission occasion (for an RD/DR link);
a transmission period (for an RD/DR link);
available time slots;
an available time-slot range;
a maximum number of time slots;
an uplink/downlink start time/subframe/slot/symbol and/or a start time/subframe/slot/symbol offset of an associated base station or assisting terminal for indicating an RD link start time;
frequency-domain information of an RD link;
an RD link subchannel number/index;
a DR link frequency offset;
an RD/DR link MCS;
an RD/DR link transport block size;
a communication range;
location information;
a priority;
a number of retransmissions for an RD/DR link; and
a validity period/time and/or a validity criterion (for RD/DR link communication).

### Message Definition for Cancelling/Releasing an AIoT Service Request

A core network (e.g., AIoTF) may elect one or more AIoT RAN(s)/Reader(s) and instruct an AIoT service request through the corresponding AIoT RANs/Readers to increase the probability of a successful response from an AIoT device. In this case, if the corresponding AIoT device has successfully transmitted a response to a paging message received from one AIoT RAN/reader triggered by the corresponding AIoT service request of the core network, if the corresponding AIoT device has successfully completed the AIoT service response/confirmation in response to the paging message received from one AIoT RAN/Reader triggered by the corresponding AIoT service request of the core network, if at least one AIoT RAN/Reader among the AIoT RANs/Readers selected by the core network (e.g., AIoTF) has received an AIoT service response/confirmation for the corresponding AIoT service request from the corresponding AIoT device, and/or if the core network (e.g., AIoTF) has received an AIoT service response/confirmation for the corresponding AIoT service request from at least one AIoT RAN/Reader among the selected AIoT RANs/Readers, the core network (e.g., AIoTF) may instruct the remaining/other AIoT RANs/Readers among the selected AIoT RANs/Readers from which it did not receive the corresponding AIoT service response/confirmation message to cancel the corresponding AIoT service request message.

For example, the core network (e.g., AIoTF) may receive an AIoT service request from an application function/application server and may select/determine one or more AIoT RANs/Readers to perform/handle the corresponding AIoT service request. The core network (e.g., AIoTF) may transmit a message for the corresponding AIoT service request (e.g., an inventory request message or a command request message) to the corresponding AIoT RANs/Readers. If the core network (e.g., AIoTF) receives an AIoT service response/confirmation message indicating success/response/confirmation for the corresponding AIoT service request message from the AIoT RANs/Readers performing/handling the corresponding AIoT service request (or from at least one AIoT RAN/Reader among the AIoT RANs/Readers), the core network (e.g., AIoTF) may initiate/perform a procedure for canceling the already requested/ongoing AIoT service request to the remaining/other AIoT RAN/Readers to which the core network (e.g., AIoTF) has already transmitted the AIoT service request message. The cancellation message may include at least one of AIoT device identification information, core network (AIoTF/AMF) device NxAP/NGAP identification information for the corresponding AIoT device, AIoT RAN/Reader NxAP/NGAP identification information, and the corresponding cause. The cancellation message may define information for instructing the cancellation of all service requests requested/ongoing for the corresponding AIoT device, thereby causing all service requests for the corresponding AIoT device to be canceled. The cancellation message may include information for distinguishing/identifying the corresponding AIoT service request (association/identification information for one AIoT service request received from the core network).

As an example, the core network (e.g., AIoTF) may initiate the procedure by transmitting an AIoT service cancellation message to one or more of the remaining/other AIoT RANs/Readers from which the core network (e.g., AIoTF) did not receive the corresponding AIoT service response/confirmation message. For convenience of description, this is referred to as an AIoT service cancellation message. This is for convenience of description and may be replaced by any other name such as an AIoT cancellation message, an AIoT release message, an AIoT request cancellation message, etc.

As another example, a core network (e.g., AIoTF) may receive an AIoT service request from an application function/application server and may select/determine one or more AIoT RAN(s)/Reader(s) to perform/handle the corresponding AIoT service request. The core network (e.g., AIoTF) may transmit a message for the corresponding AIoT service request (e.g., an inventory request message or a command request message) to the corresponding AIoT RAN(s)/Reader(s). If the core network (e.g., AIoTF) has not received a success/response/confirmation for the corresponding AIoT service request message from any of the AIoT RANs/Readers performing/handling the AIoT service request (or from at least one AIoT RAN/Reader among the AIoT RANs/Readers), the core network (e.g., AIoTF) may initiate/perform a procedure for canceling the already requested/ongoing AIoT service request to the corresponding AIoT RAN/Reader to which it has already transmitted the AIoT service request message.

As another example, an AIoT RAN/Reader may be made to initiate/perform a procedure for indicating failure of the corresponding AIoT service request if the AIoT RAN/Reader is unable to accept/accommodate the AIoT service request from the core network. A core network (e.g., AIoTF) may receive an AIoT service request from an application function/application server and may select/determine one or more AIoT RAN(s)/Reader(s) to perform/handle the corresponding AIoT service request. If the corresponding AIoT RAN/Reader is unable to accept/accommodate the corresponding AIoT service request, the AIoT RAN/Reader may transmit an AIoT service request failure message including an appropriate cause value to the corresponding core network. The failure message may include at least one of AIoT device identification information, core network (AIoTF/AMF) device NxAP/NGAP identification information for the corresponding AIoT device, AIoT RAN/Reader NxAP/NGAP identification information, and the corresponding cause. The failure message may include information for distinguishing/identifying the corresponding AIoT service request (association/identification information for one AIoT service request received from the core network).

As another example, upon receiving a message for canceling an AIoT service request (e.g., an AIoT service cancellation message) from the core network (e.g., AIoTF), the AIoT RANs/Readers having received the message may transmit a response/confirmation message to the core network (e.g., AIoTF). For convenience of description, this is referred to as an AIoT service cancellation response message. This is for convenience of description and may be replaced by any other name such as an AIoT cancellation response/confirmation message, an AIoT release response/confirmation message, an AIoT request cancellation response/confirmation message, etc. The response/confirmation message may include at least one of AIoT device identification information, core network (AIoTF/AMF) device NxAP/NGAP identification information for the corresponding AIoT device, AIoT RAN/Reader NxAP/NGAP identification information, and the corresponding cause. The response/confirmation message may include information for distinguishing/identifying the corresponding AIoT service request (association/identification information for one AIoT service request received from the core network).

As another example, an AIoT service cancellation message and/or an AIoT service cancellation response message may be provided between an AIoTF and an AIoT RAN/reader via an NxAP (or a service-based interface protocol between the AIoTF and the AIoT RAN, or an application protocol on top of the service-based interface protocol between the AIoTF and the AIoT RAN)/NGAP message.

As another example, an AIoT service cancellation message, an AIoT service cancellation response message, and/or an AIoT failure message may include information for identifying the corresponding AIoT service request. The information may include at least one of: information for identifying/distinguishing one AIoT service request/trigger requested from one core network, an AIoT service type, information for distinguishing an AIoT service request, information for indicating an AIoT service purpose, AIoT device identification information, NxAP (or a service-based interface protocol between the AIoTF and the AIoT RAN, or an application protocol on top of the service-based interface protocol between the AIoTF and the AIoT RAN)/NGAP identification information of the AIoT device at the AIoT RAN/reader, NxAP (or a service-based interface protocol between the AIoTF and the AIoT RAN, or an application protocol on top of the service-based interface protocol between the AIoTF and the AIoT RAN)/NGAP identification information of the AIoT device at the AIoTF, AIoTF identification information, and AIoT RAN/reader identification information.

As another example, an AIoT service cancellation message and/or an AIoT service cancellation response message and/or an AIoT failure message may be provided between an AIoTF and an AIoT UE Reader via a NAS message.

As another example, an AIoT service cancellation message, an AIoT service cancellation response message (or information included in the message), and/or an AIoT failure message may be provided between an AIoTF and a base station/RAN serving a UE Reader, or between an AIoTF and an AIoT RAN, via an NxAP (or a service-based interface protocol between the AIoTF and the AIoT RAN, an application protocol on top of the service-based interface protocol between the AIoTF and the RAN), or via a service-based interface protocol through an AMF and an NGAP message between the AMF and the base station.

An AIoT service cancellation message, an AIoT service cancellation response message (or information included in the message), and/or an AIoT failure message may be transmitted/received between a serving base station of a UE reader and the UE reader via an RRC message.

An AIoT service cancellation message, an AIoT service cancellation response message (or information included in the message), and/or an AIoT failure message may be transmitted/received from the AIoTF via AIoT UE reader user plane data.

Hereinafter, another embodiment of the present disclosure will be described.

An application function/application server may request an AIoT service (e.g., an inventory procedure or a command procedure) from an AIoTF. At this time, the application function/application server may transmit information necessary for the AIoT service operation. The information may be at least one of AIoT service type information (e.g., inventory or command (e.g., read, write, enable, disable)), information for AIoT RAN/Reader selection, an expected/estimated number of target AIoT devices for the service, and an expected/estimated size of a D2R response message for the service request.

The AIoTF may determine AIoT device identification information included in a paging message on an AIoT radio interface based on the information received from the application function. The AIoTF may transmit an AIoT service request message (e.g., an inventory request message or a command request message) to the AIoT RAN. The AIoT service request message may be transmitted between the AIoTF and the AIoT RAN via an AMF. For example, the AIoT service request message may be transmitted via an interface between the AIoTF and the AMF (e.g., Nz interface) and an interface between the AMF and the AIoT RAN (e.g., N2/NG interface). The AIoT service request message may be transmitted between the AIoT RAN and the AMF via NGAP. Alternatively, the AIoT service request message may be transmitted by defining a (direct) interface between the AIoTF and the AIoT RAN (e.g., Nx interface) and defining an application protocol (e.g., NxAP) provided via the interface on that interface (or a service-based interface protocol between the AIoTF and the AIoT RAN, or an application protocol on top of the service-based interface protocol between the AIoTF and the AIoT RAN).

The AIoT RAN/Reader may perform an AIoT procedure (e.g., a procedure performed in the Access Stratum between the AIoT RAN/Reader and the AIoT device) with the AIoT device via the AIoT radio interface. For this purpose, the AIoT RAN/Reader may transmit an AIoT paging message to the AIoT device. In order for the AIoT device to effectively distinguish and handle an AIoT service request procedure of an upper layer of the Access Stratum (e.g., AIoT NAS, AIoT data/application) and/or an AIoT procedure of an access layer (e.g., Access Stratum or PHY/MAC), the following methods may be applied.

For example, a paging message may request an AIoT service from an AIoT device via a downlink NAS message.

The AIoTF may generate a NAS message for an AIoT service request based on information received from an application function. The NAS message corresponds to a NAS message handled by the NAS layer/entity of the AIoTF and the AIoT device. The NAS message may include at least one of AIoT service type information, AIoT device identification information, and a security parameter.

Here, the AIoT service type information may distinguish at least one of: an inventory service/operation (or distinguishing at least one of an inventory service/operation for a single AIoT device, an inventory service/operation for a group of AIoT devices, an inventory service/operation for a plurality of AIoT devices, and an inventory service/operation for all AIoT devices through a corresponding field); a command service/operation (or distinguishing at least one of a command service/operation for a single AIoT device, a command service/operation for a group of AIoT devices, a command service/operation for a plurality of AIoT devices, and a command service/operation for all AIoT devices through a corresponding field); and a Read/Write/Enable/Disable service/operation (or distinguishing at least one of a Read/Write/Enable/Disable service/operation for a single AIoT device, a Read/Write/Enable/Disable service/operation for a group of AIoT devices, a Read/Write/Enable/Disable service/operation for a plurality of AIoT devices, and a Read/Write/Enable/Disable service/operation for all AIoT devices through a corresponding field).

For example, 1 bit may be used as information for distinguishing an AIoT service type (for the corresponding paging MAC PDU or for a downlink MAC PDU or for the corresponding MAC header) to distinguish between an inventory service/operation and a command service/operation. 2 bits may be used as information for distinguishing an additional service type for the command service/operation to distinguish between Read/Write/Enable/Disable services/operations. The AIoT device may ignore the information for distinguishing an additional service type if the AIoT service type is set to inventory. Alternatively, if the AIoT service type is set to inventory, the information for distinguishing an additional service type may be set to a reserved value and used to support future forward compatibility.

As another example, 3 bits may be used as information for distinguishing an AIoT service type to distinguish between inventory/Read/Write/Enable/Disable services/operations. The remaining 3 values out of 8 values may be set to reserved values and used to support future forward compatibility.

As another example, to support forward compatibility, 2 bits may be used as information for distinguishing an AIoT service type to distinguish between an inventory service/operation and a command service/operation. 2 bits may be used as information for distinguishing an additional service type for the command service/operation to distinguish between Read/Write/Enable/Disable services/operations. A reserved value of 1 bit (2 values) for distinguishing the AIoT service type may be used to support the addition of AIoT services/operations later. Alternatively, 1 bit may be used as information for distinguishing an AIoT service type, and the addition of AIoT services/operations later may be distinguished by adding a separate field for distinguishing the corresponding MAC PDU version/release/format/service type version, etc.

As another example, to support forward compatibility, 2 bits may be used as information for distinguishing an AIoT service type to distinguish between an inventory service/operation and a command service/operation. If the information for distinguishing the AIoT service type is set to command service/operation, a MAC header may distinguish between Read/Write/Enable/Disable services/operations by adding 2 bits as information for distinguishing an additional service type. If the information for distinguishing the AIoT service type is set to inventory service/operation, the MAC header may be configured without the 2-bit field for distinguishing an additional service type.

As another example, to support forward compatibility (for the corresponding paging MAC PDU or for a downlink MAC PDU or for the corresponding MAC header), a field for the corresponding MAC PDU (protocol) version/release/format/service type version may be included.

As another example, 1 bit may be used (for the corresponding paging MAC PDU or for a downlink MAC PDU or for the corresponding MAC header) as information for indicating whether it is for a single/multiple AIoT device(s) (or, a single/multiple AIoT device identifier(s)) to distinguish between them. In the case of a group identifier, a value for distinguishing a single AIoT device and a value for distinguishing a group of AIoT devices may be used separately within the value for distinguishing a single AIoT device (or a single AIoT device identifier). The AIoT device may check whether the terminal identification information included in the paging message matches a single AIoT device identifier of the AIoT device and/or a group of AIoT devices identifier to which the AIoT device belongs. If the terminal identification information included in the paging message matches one or more of its own single AIoT device identifier and the group of AIoT devices identifier to which it belongs, the AIoT device may perform a random access procedure with the AIoT base station/reader.

As another example, if an AIoT device identification information field is included (for the corresponding paging MAC PDU or for a downlink MAC PDU or for the corresponding MAC header), a specific value for the AIoT device identification information (e.g., all 1s or all 0s) may be used as information for instructing paging for all AIoT devices within the corresponding AIoT RAN/reader coverage.

As another example, information/a field may be included (for the corresponding paging MAC PDU or for a downlink MAC PDU or for the corresponding MAC header) for indicating/distinguishing whether it is paging/reception for all AIoT devices within the corresponding AIoT RAN/reader coverage. This may be provided by defining a physical channel separate from the PRDCH, provided by scrambling the corresponding information with a specific identifier within the PRDCH, provided by adding the corresponding field within the corresponding MAC PDU/header, or provided by defining a field for distinguishing the corresponding MAC PDU/header.

As another example, a paging message for all AIoT devices within the corresponding AIoT RAN/reader coverage (e.g., a paging MAC PDU) and a paging message for a single/group of AIoT devices within the corresponding AIoT RAN/reader coverage (e.g., a paging MAC PDU) (for the corresponding paging MAC PDU or for a downlink MAC PDU or for the corresponding MAC header) may be defined to have different formats. As an example, a paging message for a single/group AIoT device may include an AIoT device identification information field (and/or an information field for identifying an AIoT device) within the corresponding paging MAC PDU (or the corresponding paging MAC header or a NAS message/container included in the corresponding paging message). On the other hand, a paging message for all AIoT devices may be made not to include an AIoT device identification information field (and/or an information field for identifying an AIoT device) within the corresponding paging MAC PDU (or the corresponding paging MAC header or a NAS message/container included in the corresponding paging message). The paging message format for a single/group AIoT device and the paging message format for all AIoT devices may be distinguished through at least one of: information for distinguishing the corresponding MAC PDU within the corresponding MAC header, information for distinguishing the corresponding MAC PDU format, a specific bit within information for distinguishing that the corresponding MAC PDU is a paging message, logical channel identification information included in the corresponding MAC PDU, PDU-type/data type identification information included in the corresponding MAC PDU, and service type information included in the corresponding MAC PDU.

As another example, 2 bits may be used as information for distinguishing at least one of a single AIoT device, a plurality of AIoT devices, a group of AIoT devices, and all AIoT devices within the corresponding AIoT RAN/reader coverage to distinguish between them (for the corresponding paging MAC PDU or for a downlink MAC PDU or for the corresponding MAC header).

As another example, in the case of a group identifier, information indicating whether it is a single/multiple AIoT device(s) (or, a single/multiple AIoT device identifier(s)) may be configured to be set to single AIoT device, and if applicable, an additional field for distinguishing and indicating the group of AIoT devices identifier may be included. If the information indicating whether it is a single/multiple AIoT device(s) (or, a single/multiple AIoT device identifier(s)) is set to multiple AIoT devices, the MAC header may be configured without the additional field for distinguishing and indicating the group of AIoT devices identifier.

As another example, if the corresponding paging MAC PDU indicates paging for all AIoT devices through information/a field for indicating/distinguishing whether it is paging/reception for all devices, and/or if an AIoT device identification information field is not included (for the corresponding paging MAC PDU or for a downlink MAC PDU or for the corresponding MAC header), the AIoT device may ignore information for indicating whether a single AIoT device or multiple AIoT devices (or a single AIoT device identifier or multiple AIoT device identifiers) is (are) included.

As another example, 2 bits may be used as information for distinguishing an AIoT service type to distinguish at least one of an inventory service/operation for a single AIoT device, an inventory service/operation for multiple AIoT devices, a command service/operation for a single AIoT device, and a command service/operation for multiple AIoT devices. 2 bits may be used as information for distinguishing an additional service type for the command service/operation to distinguish between Read/Write/Enable/Disable services/operations.

As another example, 4 bits (16 values) may be used as information for distinguishing an AIoT service type for distinguishing between inventory/Read/Write/Enable/Disable services/operations for a single AIoT device and inventory/Read/Write/Enable/Disable services/operations for multiple AIoT devices.

AIoT device identification information may represent, for example, AIoT device identification information included in an NxAP (or a service-based interface protocol between an AIoTF and an AIoT RAN, or an application protocol on top of the service-based interface protocol between an AIoTF and an AIoT RAN/reader)/NGAP message between the AIoTF and the AIoT RAN, or AIoT device identification information used in the Non-Access Stratum (NAS) layer/entity of the AIoTF and the AIoT device. The AIoT device identification information may represent at least one of: a full permanent Ambient IoT Device Identifier configured for an AIoT device, a part of an Ambient IoT Device Identifier, the entirety of a permanent AIoT device identifier which has been security (e.g., cyphering/encryption, integrity protection, Message Authentication Code, hash function and/or device authentication) processed/verified, a part of a permanent AIoT device identifier which has been security processed/verified, a code calculated/generated/derived/determined through security processing/verification for the corresponding AIoT device (or the entire/partial permanent AIoT device identifier), a code associated with the corresponding AIoT device (or the entire/partial permanent AIoT device identifier), and filtering/mask information for determining/extracting AIoT device identification information. A permanent AIoT device identifier may be assigned by an operator or a 3rd party. A permanent AIoT device identifier may include one of a network identifier (e.g., Mobile Country Code (MCC)+Mobile Network Code (MNC) and/or Network Identifier (NID)) or information used to identify a 3rd party. A permanent AIoT device identifier may include information used to distinguish different AIoT devices within a network identifier (e.g., MCC+MNC and/or NID) or information used to identify a 3rd party (e.g., Electronic Product Code (EPC) or other local/internal identification information). In any signaling process, one or more pieces of AIoT device identification information may be used for a single AIoT device. For example, a network identifier (e.g., MCC+MNC and/or NID) or information used to identify a 3rd party may be used as a first AIoT device identification information, and information used to distinguish different AIoT devices within a network identifier (e.g., MCC+MNC and/or NID) or information used to identify a 3rd party (e.g., Electronic Product Code (EPC) or other local/internal identification information) may be used as a second AIoT device identification information. At least one of the first AIoT device identification information and the second AIoT device identification information (or at least one of the whole/part of the first AIoT device identification information and the whole/part of the second AIoT device identification information) may be security processed/verified and transmitted/received. (e.g., first AIoT device identification information (plaintext), second AIoT device identification information (ciphertext), or vice versa)

A security parameter may represent, for example, at least one of: a key, key identification information, a fresh value, a counter, a token, a verification value, a random parameter, an algorithm, and device credential/profile used for security (e.g., cyphering/encryption, integrity protection, Message Authentication Code, hash function and/or device authentication) processing/verification of the entire/partial permanent AIoT device identifier at the AIoTF and/or the AIoT device.

The AIoTF may transmit an NxAP/NGAP message including a NAS message for an AIoT service (e.g., inventory or command) request to the AIoT RAN. The (NxAP/NGAP) request message may further include, in addition to the NAS message, at least one of: the corresponding AIoT device identification information included in a paging message, an expected/estimated number of target AIoT devices for the service, and an expected/estimated size of a D2R response message for the service request.

For example, an AIoT RAN/reader may transmit a paging message including a NAS message for an AIoT service request to an AIoT device. The paging message may be transmitted to the AIoT device via a PRDCH by a specific downlink/R2D MAC PDU (or MAC Control element or Paging MAC PDU). The AIoT device may receive the MAC PDU via the PRDCH. A downlink/R2D MAC PDU (or MAC Control element or Paging MAC PDU) including a paging message may include explicit instruction information/a field for distinguishing it within the MAC PDU. Alternatively, a downlink/R2D MAC PDU (or MAC Control element or Paging MAC PDU) including a paging message may be implicitly distinguished through the presence of any field/field combination included within the MAC PDU.

As an example, the paging MAC PDU may be indicated by including at least one of: information for indicating whether a NAS message/container/security is included/processed for an AIoT service request, association/identification information for one AIoT service request received from a core network, information for indicating whether a paging message is included, information for distinguishing a MAC PDU format for paging, and information for distinguishing an AIoT service type. The MAC PDU may be indicated to include/represent a paging message through at least one of: an AIoT service type, information for indicating whether it is the first message for the corresponding AIoT service type, AIoT device identification information, AIoT RAN/reader identification information, information for indicating whether a NAS message/container is included, and information for indicating whether an Access Stratum Identifier (AS ID) is included/applied.

As another example, a message for paging transmitted by an AIoT RAN/reader to an AIoT device may be made not to include a NAS message/container received from an AIoTF. As an example, when an AIoT RAN/reader transmits a message for paging including instruction information for contention-based random access to the corresponding AIoT device, the message may be made not to include a NAS message/container received from the AIoTF. Subsequently, a NAS message/container received from the AIoTF may be included in an AIoT MSG2 and/or R2D data transmission. The paging message may be transmitted to the AIoT device via a PRDCH by a specific downlink/R2D MAC PDU (or MAC Control element or Paging MAC PDU). The AIoT device may receive the MAC PDU via the PRDCH. A downlink/R2D MAC PDU (or MAC Control element or Paging MAC PDU) including a paging message may include explicit instruction information/a field for distinguishing it within the MAC PDU. Alternatively, a downlink/R2D MAC PDU (or MAC Control element or Paging MAC PDU) including a paging message may be implicitly distinguished through the presence of any field/field combination included within the MAC PDU. For example, it may be indicated that the MAC PDU includes/represents a paging message through at least one of: an AIoT service type, information for indicating whether it is the first message for the corresponding AIoT service type, AIoT device identification information, AIoT RAN/reader identification information, and information for indicating whether an AS ID is included/applied.

As another example, an AIoT RAN/reader may transmit a paging message to an AIoT device via a paging logical channel/MAC-PDU for an AIoT service request. A logical channel identifier/MAC-PDU-identifier/distinguishing information for distinguishing the paging logical channel/MAC-PDU may be defined. The MAC PDU (or MAC Control element or Paging MAC PDU) may be transmitted to the AIoT device via a PRDCH including the logical channel identifier/MAC-PDU-identifier/distinguishing instruction information. The AIoT device may receive the MAC PDU via the PRDCH.

Here, information for indicating whether an AS ID is included/applied represents, for example, information for indicating whether an Access Stratum (AS) identification information used for (at least) D2R scheduling and R2D reception purposes is included/applied. The AS ID may be one of a random ID included in a first D2R message (or AIoT message1, MSG1) or an ID assigned by a reader to an AIoT device. A subsequent R2D message including the information may include the corresponding AS ID so that the AIoT device may use the AS ID to distinguish and use messages transmitted to itself.

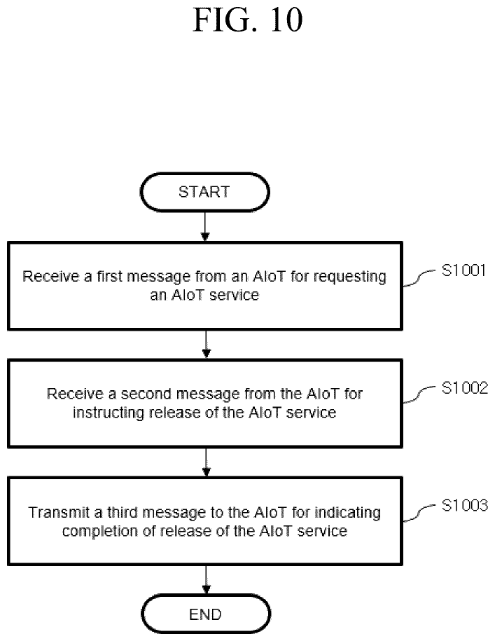

FIG. 10 is a flowchart showing a method of operating a reader according to an embodiment.

Referring to FIG. 10, a reader receives, from the AIoTF (Ambient Internet of Things Function), a first message for requesting an AIoT (Ambient Internet of Things) service (S1001). Further, after receiving the first message, the reader receives, from the AIoTF, a second message for instructing release of the AIoT service (S1002), and in response to the second message, transmits, to the AIoTF, a third message for indicating completion of release of the AIoT service (S1003).

After receiving the first message, the reader may transmit a fourth message to an AIoT device for paging. Here, the fourth message may be an AIoT paging MAC protocol data unit (PDU), and the MAC PDU may include information (or a field) indicating whether a security parameter is included.

Meanwhile, the first message may further include, for example, at least one of AIoT device identification information and a security parameter, and may be received via NGAP (NG Application Protocol) between the AIoTF and a base station. The AIoT device identification information may include one of permanent AIoT device identification information, first security-processed identification information, and filtering information, and the security parameter may be a random parameter used to generate second security-processed identification information. Here, a matching between the generated second security-processed identification information and the received first security-processed identification information may be checked.

In addition, the second message may include, for example, identification information associated with the request for the AIoT service, AIoTF identification information, and cause information.

Further, the third message may include identification information associated with the request for the AIoT service and AIoTF identification information.

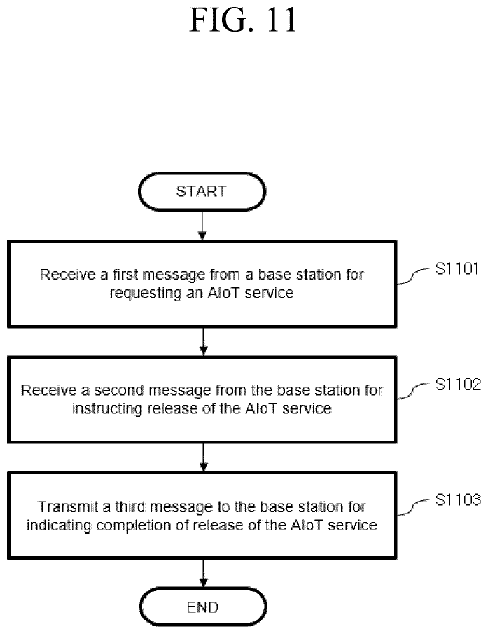

FIG. 11 is a flowchart showing a method of operating a reader according to another embodiment.

Hereinafter, a method of operation when a reader is a terminal reader is described with reference to FIG. 11.

Referring to FIG. 11, the terminal reader receives, from a base station, a first message for requesting an AIoT (Ambient Internet of Things) service (S1101). Further, after receiving the first message, the terminal reader receives, from the base station, a second message for instructing release of the AIoT service (S1102), and in response to the second message, transmits, to the base station, a third message for indicating completion of release of the AIoT service (S1103).

After receiving the first message, the terminal reader may transmit a fourth message to an AIoT device for paging. Here, the fourth message may be an AIoT paging MAC protocol data unit (PDU), and the MAC PDU may include information (or a field) indicating whether a security parameter is included.

Meanwhile, the first message may further include, for example, at least one of AIoT device identification information and a security parameter, and may be received via Radio Resource Control (RRC). That is, the first message may be an RRC message.

The AIoT device identification information may include one of permanent AIoT device identification information, first security-processed identification information, and filtering information, and the security parameter may be a random parameter used to generate second security-processed identification information. Here, a matching between the generated second security-processed identification information and the received first security-processed identification information may be checked.

In addition, the second message may include, for example, identification information associated with the request for the AIoT service, AIoTF identification information, and cause information, and may be received via Radio Resource Control (RRC). That is, the second message may be an RRC message.

Further, the third message may include identification information associated with the request for the AIoT service and AIoTF identification information, and may be transmitted via Radio Resource Control (RRC). That is, the third message may be an RRC message.

The embodiments described up to now may be implemented in various ways. For example, the embodiments may be implemented by hardware, firmware, software, or a combination thereof. Details will be described below with reference to the accompanying drawings.

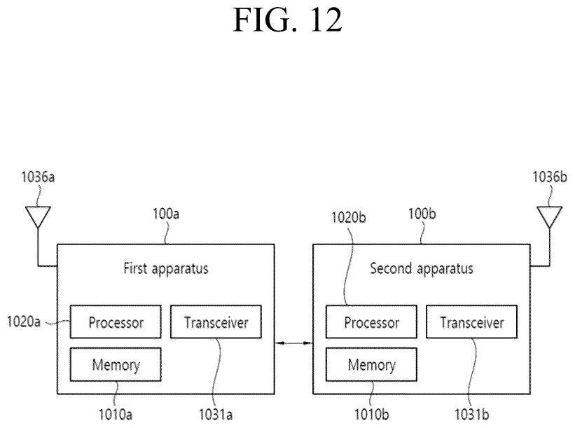

FIG. 12 is a block diagram showing apparatuses according to an embodiment of the disclosure.

Referring to FIG. 12, a wireless communication system may include a first apparatus 100a and a second apparatus 100b.

The first apparatus 100a may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medical apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medical apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may be tasked with executing the previously mentioned functions, procedures, and/or methods. The processor 1020a may be capable of implementing one or more protocols. For example, the processor 1020a may perform and manage one or more layers of a radio interface protocol. The memory 1010a may be connected to the processor 1020a, and configured to store various types of information and/or instructions. The transceiver 1031a may be connected to the processor 1020a, and controlled to transceive radio signals.

The second apparatus 100b may include at least one processor such as a processor 1020b, at least one memory device such as a memory 1010b, and at least one transceiver such as a transceiver 1031b. The processor 1020b may be tasked with executing the previously mentioned functions, procedures, and/or methods. The processor 1020b may be capable of implementing one or more protocols. For example, the processor 1020b may manage one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

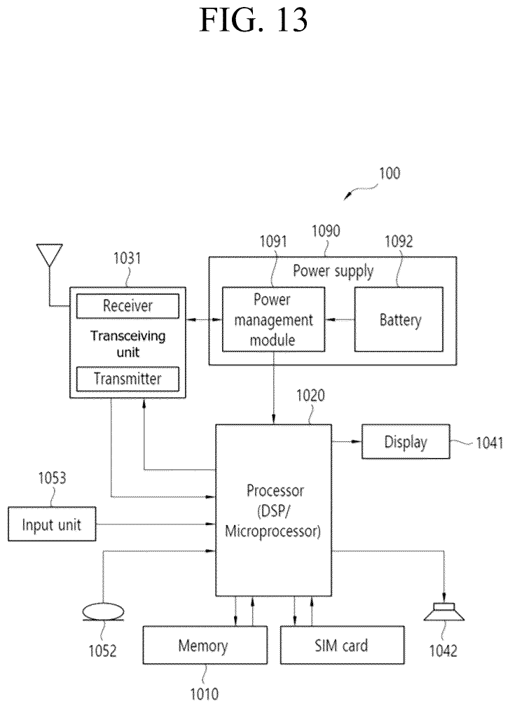

FIG. 13 is a block diagram showing a terminal according to an embodiment of the disclosure.

In particular, FIG. 13 illustrates the previously described apparatus of FIG. 12 in more detail.

The apparatus includes a memory 1010, a processor 1020, a transceiving unit 1031 (e.g., transceiving circuit), a power management module 1091 (e.g., power management circuit), a battery 1092, a display 1041, an input unit 1053 (e.g., input circuit), a loudspeaker 1042, a microphone 1052, a subscriber identification module (SIM) card, and one or more antennas. Some constituent elements are referred to as a unit in the disclosure. However, the embodiments are not limited thereto. For example, such term “unit” may also refer to a circuit block, a circuit, or a circuit module.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management module 1091 manages a power for the processor 1020 and/or the transceiver 1031. The battery 1092 supplies power to the power management module 1091. The display 1041 outputs the result processed by the processor 1020. The input unit 1053 may be an individual circuit that receives an input from a user or other devices and convey the received input with associated information to the processor 1020. However, the embodiments are not limited thereto. For example, the input unit 1053 may be implemented as at least one of touch keys or buttons to be displayed on the display 1041 when the display 1041 is capable of sensing touches, generating related signals according to the sensed touches, and transferring the signals to the processor 1020. The SIM card is an integrated circuit used to securely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. The embodiments described in the disclosure may be implemented as software program or application. In this case, such software program or application may be stored in the memory 1010. In response to a predetermined event, the software program or application stored in the memory 1010 may be fetched and executed by the processor 1020 for performing the function and the method described in this disclosure. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020, receives, and transmits a radio signal under control of the processor 1020. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives audio input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

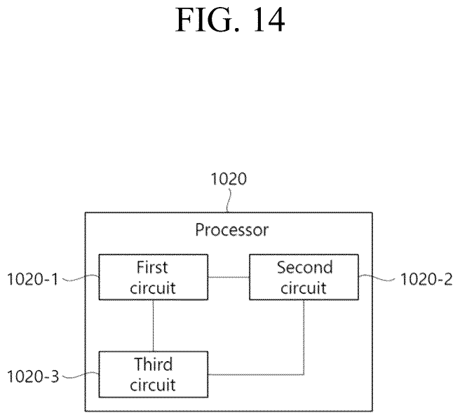

FIG. 14 is a block diagram of a processor in accordance with an embodiment.

Referring to FIG. 14, a processor 1020 may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP) and may include at least one of a digital signal processor (DSP), a central processing unit (CPU), and a graphics processing unit (GPU).

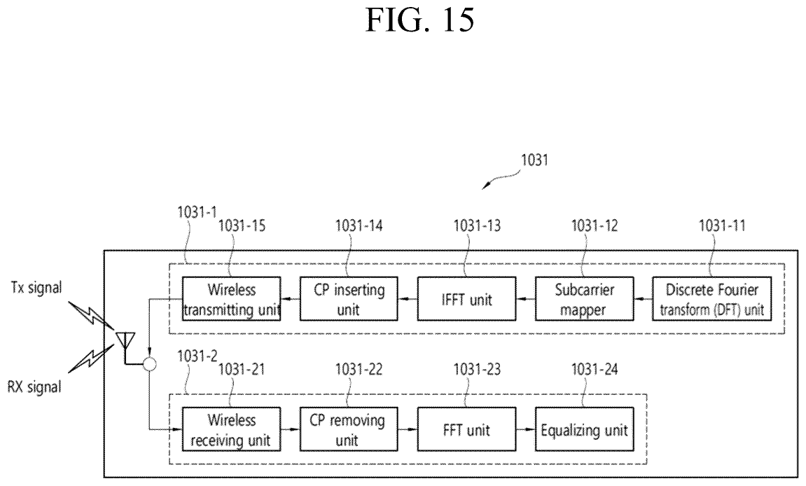

FIG. 15 is a detailed block diagram of a transceiver of a first apparatus shown in FIG. 12 or a transceiving unit of an apparatus shown in FIG. 13.

Referring to FIG. 15, the transceiving unit 1031 (e.g., transceiving circuit) includes a transmitter 1031-1 and a receiver 1031-2. The transmitter 1031-1 includes a discrete Fourier transform (DFT) unit 1031-11 (e.g., DFT circuit), a subcarrier mapper 1031-12 (e.g., subcarrier mapping circuit), an IFFT unit 1031-13 (e.g., IFFT circuit), a cyclic prefix (CP) insertion unit 1031-14 (e.g., CP insertion circuit), and a wireless transmitting unit 1031-15 (e.g., wireless transmitting circuit). The transmitter 1031-1 may further include a modulator. Further, the transmitter 1031-1 may for example include a scramble unit (e.g., scrambling circuit), a modulation mapper, a layer mapper, and a layer permutator, which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some constituent elements are referred to as a unit in the disclosure. However, the embodiments are not limited thereto. For example, such term “unit” may also refer to a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21 (e.g., wireless receiving circuit), a CP removing unit 1031-22 (e.g., CP removing circuit), an FFT unit 1031-23 (e.g., FFT circuit), and an equalizing unit 1031-24 (e.g., equalizing circuit). The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

According to the embodiments of the disclosure, success and/or failure of an ambient IoT service may be handled effectively in a wireless communication system.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

What is claimed is:

1. A method of operating a reader in a wireless communication system, the method comprising:
receiving, from an ambient internet of things function (AIoTF), a first message for requesting an ambient internet of things (AIoT) service;
after receiving the first message, receiving, from the AIoTF, a second message for instructing release of the AIoT service; and
in response to the second message, transmitting, to the AIoTF, a third message for indicating completion of release of the AIoT service.

2. The method of claim 1, further comprising:
after receiving the first message, transmitting a fourth message to an AIoT device for paging.

3. The method of claim 1, wherein the first message includes at least one of AIoT device identification information and a security parameter, and the first message is received via NG application protocol (NGAP) between the AIoTF and a base station.

4. The method of claim 3, wherein the AIoT device identification information includes one of permanent AIoT device identification information, first security-processed identification information, and filtering information, and
wherein the security parameter is a random parameter used to generate second security-processed identification information.

5. The method of claim 2, wherein the fourth message includes information indicating whether a security parameter is included.

6. The method of claim 1, wherein the second message includes identification information associated with the request for the AIoT service, AIoTF identification information and cause information.

7. The method of claim 1, wherein the third message includes identification information associated with the request for the AIoT service and AIoTF identification information.

8. A reader in a wireless communication system, comprising:
at least one processor; and
at least one memory configured to store instructions and operably electrically connectable to the at least one processor,
wherein operations performed based on the instructions executed by the at least one processor comprise:
receiving, from an ambient internet of things function (AIoTF), a first message for requesting an ambient internet of things (AIoT) service;
after receiving the first message, receiving, from the AIoTF, a second message for instructing release of the AIoT service; and
in response to the second message, transmitting, to the AIoTF, a third message for indicating completion of release of the AIoT service.

9. The reader of claim 8, wherein operations performed based on the instructions executed by the at least one processor comprise:
after receiving the first message, transmitting a fourth message to an AIoT device for paging.

10. The reader of claim 8, wherein the first message includes at least one of AIoT device identification information and a security parameter, and the first message is received via NG application protocol (NGAP) between the AIoTF and a base station.

11. The reader of claim 10, wherein the AIoT device identification information includes one of permanent AIoT device identification information, first security-processed identification information, and filtering information, and
wherein the security parameter is a random parameter used to generate second security-processed identification information.

12. The reader of claim 9, wherein the fourth message includes information indicating whether a security parameter is included.

13. The reader of claim 8, wherein the second message includes identification information associated with the request for the AIoT service, AIoTF identification information and cause information.

14. The reader of claim 8, wherein the third message includes identification information associated with the request for the AIoT service and AIoTF identification information.
